(19) United States
(12) Patent Application Publication
(10) Pub. No.: US 2008/0048602 A1
(43) Pub. Date: Feb. 28, 2008

(54) Vehicle drive

(76) Inventor: Conrad Rossel, Syrgenstein (DE)

Correspondence Address: KLAUS J. BACH, 4407 TWIN OAKS DRIVE, MURRYSVILLE, PA, 15668, US

(21) Appl. No.: 11/895,291

(22) Filed: Aug. 23, 2007

Related U.S. Application Data
(63) Continuation-in-part of application No. PCT/EP2006/001526, filed on Feb. 21, 2006.

(30) Foreign Application Priority Data
Mar. 2, 2005 (DE) 10 2005 009 428.7

(51) Int. Cl. H02P 1/02; B60K 1/00; H02P 1/00

(52) U.S. Cl. 318/504; 180/65.8; 903/906

(57) ABSTRACT

In an electric or hybrid vehicle drive having an electric machine, which can be operated either as a motor or as a generator, and includes an electronic power system, wherein a power source is connected to a direct voltage terminal of the electronic power system, and the electric machine is connected to an alternating voltage terminal thereof, an inverting, bidirectional DC/DC transformer is connected between the direct voltage terminal of the electronic power system and the power source providing the electric machine with a voltage in the motor mode of the electric machine, which is higher than, or equal to or lower than, the voltage of the power source, and the DC/DC transformer for charging the power source in the generator mode of the electric machine.

This is a Continuation-In-Part Application of Pending International Patent Application PCT/EP2006/001526 filed Feb. 21, 2006 and claiming the priority of German Patent Application 10 2005 009 428.7 filed Feb. 21, 2006.

### BACKGROUND OF THE INVENTION

The invention relates to a motor vehicle drive, specifically an electric or hybrid vehicle drive, including an electric machine which can be operated as a motor or as a generator and an electronic power control system for controlling the power consumed or generated by the electric machine.

DE 199 21 450 C1 discloses an electric vehicle drive having an electric machine which can either be operated as a motor or as a generator. The vehicle drive according to DE 199 21 450 C1 has an electronic power system which is embodied as a three-phase inverter, with a power source being connected to a direct voltage terminal of the electronic power system, and the electric machine being connected to an alternating voltage terminal thereof. According to DE 199 21 450 C1, a bidirectional DC/DC transformer is connected between the electronic power system and the power source so that, on the one hand, in the motor mode of the electric machine said electric machine can be supplied with a voltage, and that, on the other hand, in the generator mode of the electric machine a voltage which is made available by said electric machine can be used to charge the power source. In the vehicle drive which is disclosed in DE 199 21 450 C1, in the motor mode of the electric machine said electric machine can be supplied only with voltages which are higher than or equal to the voltage of a power source. This is disadvantageous in particular if only low voltages are required at low rotational speeds of the electric machine, for example when starting. In this case, in vehicle drives which are known from the prior art high losses occur, specifically on the one hand losses caused by ripple currents in the electric machine and on the other hand switching losses within the electronic power system.

It is therefore the object of the present invention to provide a novel vehicle drive which overcomes these problems.

### SUMMARY OF THE INVENTION

In an electric or hybrid vehicle drive having an electric machine, which can be operated either as a motor or as a generator, and includes an electronic power system, wherein a power source is connected to a direct voltage terminal of the electronic power system, and the electric machine is connected to an alternating voltage terminal thereof, an inverting, bidirectional DC/DC transformer is connected between the direct voltage terminal of the electronic power system and the power source providing the electric machine with a voltage in the motor mode of the electric machine, which is higher than, or equal to or lower than, the voltage of the power source, and the DC/DC transformer for charging the power source in the generator mode of the electric machine.

By using the vehicle drive according to the invention it is possible, in the motor mode of the electric machine, to operate the electric machine with voltages which are higher than, or equal to or even lower than, the voltage of the power source. This makes it possible to minimize losses at low rotational speeds in the motor mode. As a result, losses caused by ripple currents in the electric machine and switching losses in the electronic power system are minimized. Since, furthermore, the power source can be unloaded from the electric machine in the generator mode of the electric machine in the vehicle drive according to the invention; the invention offers new possibilities for the overall optimization of an electric or hybrid vehicle drive. The vehicle drive according to the invention is distinguished by an inverting and bidirectional DC/DC transformer which is simple in terms of circuit technology.

A negative pole of the power source is preferably connected to a positive pole of the direct voltage terminal of the electronic power system, and a positive pole of the power source is preferably connected to a negative pole of the direct voltage terminal of the electronic power system with the inverting, bidirectional DC/DC transformer being connected therebetween.

According to one advantageous embodiment of the invention, the inverting, bidirectional DC/DC transformer can be changed over to a non inverting, bidirectional DC/DC transformer by a switch in order to reduce the voltage loading, in which case the positive pole of the power source is then connected to the positive pole of the DC voltage terminal of the electronic power system, and the negative pole of the power system is connected to the negative pole of the DC voltage terminal of the electronic power system with intermediate connection of the bidirectional DC/DC converter.

The invention will become more readily apparent from the following description of an exemplary embodiment of the invention described below in greater detail with reference to the accompanying drawings:

### BRIEF DESCRIPTION OF THE DRAWINGS

FIG. 1 shows a circuit diagram of a vehicle drive according to the invention according to a first exemplary embodiment of the invention; and

FIG. 2 is a circuit diagram of a second exemplary embodiment of the invention for a vehicle drive.

### DESCRIPTION OF THE EXEMPLARY EMBODIMENTS

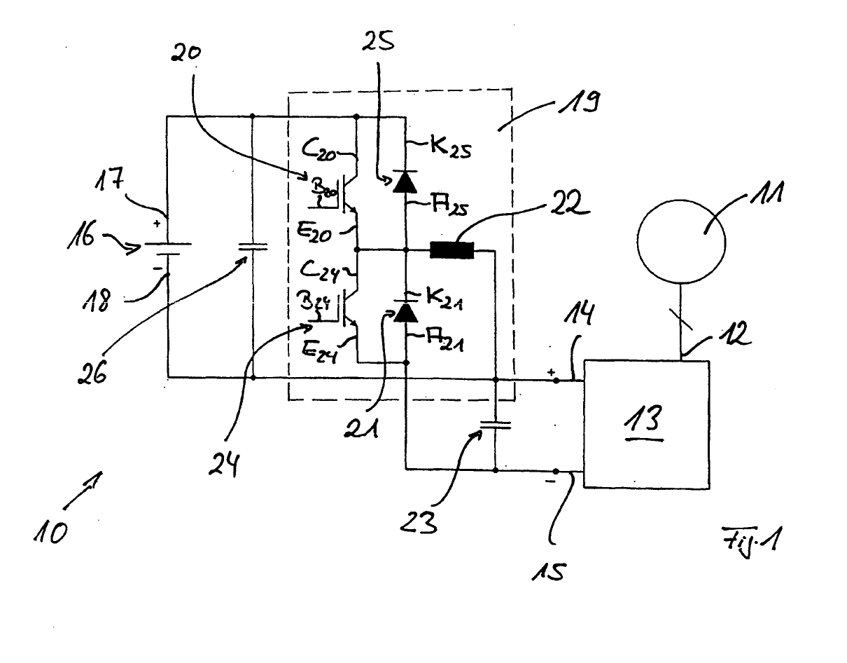

FIG. 1 shows a circuit diagram of a preferred embodiment of the vehicle drive 10 according to the invention. The vehicle drive 10 in FIG. 1 comprises an electric machine 11 which can either be operated as a motor or as a generator. The electric machine 11 is connected to an alternating voltage terminal 12 of an electronic power system 13. A direct voltage terminal of the electronic power system is formed by a positive pole 14 and a negative pole 15, with a power source 16, specifically a battery, being connected to the direct voltage terminal of the electronic power system 13. The power source 16 has a positive pole 17 and a negative pole 18.

In accordance with the present invention, an inverting, bidirectional DC/DC transformer 19 is connected between the power source 16 and the direct voltage terminal of the electronic power system 13. By using the inverting, bidirectional DC/DC transformer 19 it is possible to operate the electric machine 11 with a voltage in the motor mode of said electric machine 11, which voltage is higher than or equal to or lower than the voltage of the power source 16. Furthermore, the power source 16 can be charged in the generator mode of the electric machine 11. According to FIG. 1, the negative pole 18 of the power source 16 is connected directly to the positive pole 14 of the direct voltage terminal of the electronic power system 13, while the positive pole 17 of the power source 16 is connected to the negative pole 15 of the direct voltage terminal of the electronic power system 13 with intermediate connection of the DC/DC transformer 19. The DC/DC transformer 19 has, according to FIG. 1, two transistors, two diodes and an inductor, with these assemblies of the DC/DC transformer 19 being connected to the electronic power system 13 and the power source 16 as follows:

A first transistor 20 of the inverting, bidirectional DC/DC transformer 19 is connected by its collector C₂₀ to the positive pole 17 of the power source 16. A first diode 21 is connected by its cathode K₂₁ to the emitter E₂₀ of the first transistor 20, and the inductor 22 is connected to a first terminal. The anode A₂₁ of the first diode 21 is connected to the negative pole 15 of the direct voltage input of the electronic power system 13; in contrast, the inductor 22 is connected, on one hand, directly to the positive pole 14 by a second terminal, and, on the other hand, to the negative pole 15 of the direct voltage input of the electronic power system 13 with a capacitor 23 connected therebetween. In addition to the first transistor 20, the first diode 21 and the inductor 22, the DC/DC transformer 19 also includes a second transistor 24 and a second diode 25.

The second diode 25 is connected here in parallel with the first transistor 20, specifically in such a way that the cathode K₂₅ of the second diode 25 is connected to the collector C₂₀ of the first transistor 20, and that the anode A₂₅ of the second diode 25 is connected to the emitter E₂₀ of the first transistor 20. The second transistor 24 is connected in parallel with the first diode 21, specifically in such a way that the first diode 21 acts with the cathode K₂₁ on the collector C₂₄ of the second transistor 24, while the anode A₂₁ of the first diode 21 is connected to the emitter E₂₄ of the second transistor 24. It follows herefrom that the emitter E₂₀ of the first transistor 20 is connected to the collector C₂₄ of the second transistor 24. Furthermore, the emitter E₂₄ of the second transistor 24 acts, like the anode A₂₁ of the first diode 21, on the negative pole 15 of the direct voltage input of the electronic control system 13. A capacitor 26 which is not directly a component of the DC/DC transformer 19 is connected in parallel with the power source 16.

The two transistors 20 and 24 furthermore each have a base B₂₀ and B₂₄, with a gate drive (not illustrated) being connected to the base B₂₀ of the transistor 20 and a gate drive (not illustrated) being connected to the base B₂₄ Of the transistor 24, respectively. As a result, either the first transistor 20 or the second transistor 24 can be switched on or off with a specific frequency independently of the electric machine 11 being operated in the motor mode or the generator mode of.

In the motor mode of the electric machine 11, the first transistor 20 is switched on and off with a certain frequency, while the second transistor 24 is switched off continuously. In the times of the switching cycle in which the first transistor 20 is switched on, the inductor 22 is charged via the power source 16, specifically by the fact that, when the first transistor 20 is switched on, a current flows starting from the positive pole 17 of the power source 16 and extending via the first transistor 20 and the inductor 22 in the direction of the negative pole 15 of the DC voltage input of the electronic power system 13. In the times of the switching cycle in which the first transistor 20 is switched off, the energy of the inductor 22 is discharged via the first diode 21 in the direction of the negative pole 15 of the DC voltage input of the electronic power system 13. By selecting the clock ratio (t_on/t_off) of the first transistor 20 when the second transistor 24 is switched off continuously, it is possible, in the motor mode of the electric machine 11, to supply said electric machine 11 with voltages which are higher than or equal to or else lower than, the voltage of the power source 16.

In the generator mode of the electric machine 11, the second transistor 24 is switched on and off with a specific clock frequency, whereas the first transistor 20 remains switched off continuously. In the times in which the second transistor 24 is switched on in the generator mode of the electric machine 11, a circuit between the positive pole 14 of the direct voltage terminal of the electronic power system 13, the inductor 22, the circuit including the second transistor 24 and the negative pole 15 of the electronic power system 13 is closed so that a current flows via this circuit and the inductor 22 stores energy. In the times in which the second transistor 24 is switched off in the generator mode of the electric machine 11, the inductor 22 discharges via the second diode 24 in the direction of the power source 16, whereas the first diode 21 switches off. The power source 16 can be charged by virtue of the clocked switching on and switching off of the second transistor 24 in the generator mode of the electric machine 11.

The two transistors 20 and 24 are embodied, for example, as IGBT transistors (Insulated Gate Bipolar Transistor). The transistors 20 and 24, can, however, alternatively also be embodied as Mosfet transistors. Both transistors 20 and 24 are embodied as NPN-type transistors. Which transistor is preferred is dependent, inter alia, on the voltage.

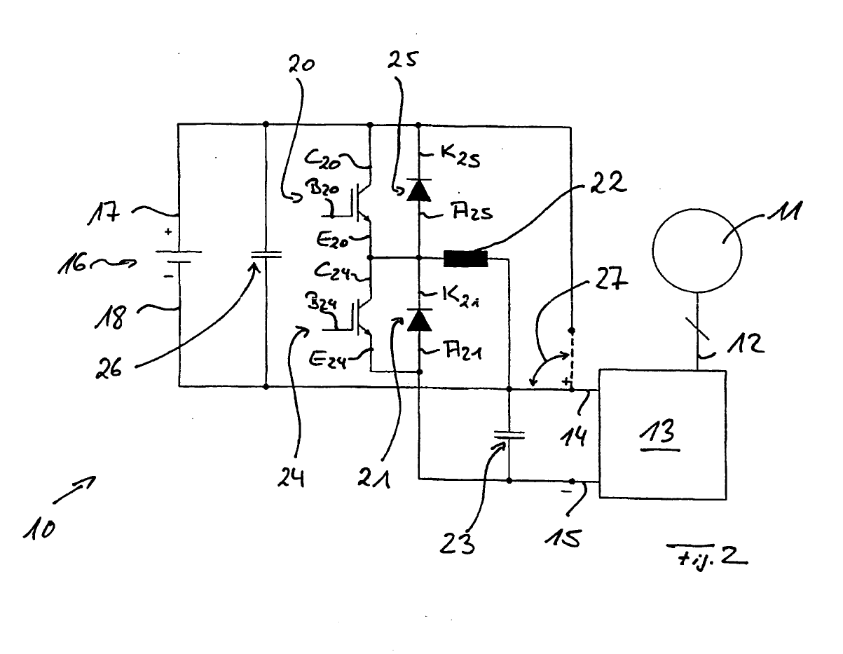

FIG. 2 shows an advantageous development of the vehicle drive 10 according to the invention, identical reference numerals are used for identical assemblies in order to avoid unnecessary repetitions. In the exemplary embodiment of FIG. 2, the vehicle drive 20 has a selective switch 27. By using the selector switch 27, the inverting, bidirectional DC/DC transformer 19 can be changed into a non inverting, bidirectional DC/DC transformer. The selector switch 27 is connected for this purpose to the positive pole 14 of the direct voltage input of the electronic power system 13, in which case, in a first position of the selector switch 27 for providing the inverting DC/DC converter, the positive pole 14 of the direct voltage input of the electronic power system 13 is connected to the negative pole 18 of the power source 16. In order to provide the non inverting DC/DC converter, the positive pole 14 of the direct voltage input of the electronic power system 13 is connected to the positive pole 17 of the power source 16. In the position of the selector switch 27 in which the non inverting DC/DC transformer is present (dashed lines in FIG. 2), it is not possible to drive the electric machine 11 in the motor mode of said electric machine 11 with voltages which are lower than the voltage of the power source 16. However, in this case the voltage load on the semiconductor components is less. Furthermore, in this case the bi-directionality of the DC/DC transformer is made possible by virtue of the fact that, in the generator mode of the electric machine 11, the second transistor 24 is opened continuously, that is to say in a non pulsed fashion. As a result, a circuit between the poles 14 and 15 of the electronic power system 13 and the power source 16 is closed. In order to charge the power source 16, a voltage which is higher than the current voltage of the power source 16 must be present at the electronic power system.

The vehicle drive according to the invention can be operated with variable voltages above and below a voltage of a power source both in the motor mode and with generator mode of operation. Particularly at low rotational speeds of the motor-operated electric machine it is possible to significantly reduce losses. The invention permits the efficiency of the electrical or hybrid vehicle drives to be optimized. The vehicle drive according to the invention is distinguished by a simple circuit design.

What is claimed is:

1. A vehicle drive for an electric or hybrid vehicle having an electric machine (11) operable either as a motor or as a generator, and including an electronic power system (13), a power source (16) with a DC voltage terminal, and the electric machine (11) connected to an alternating voltage terminal of the electronic power system (13), and an inverting, bidirectional DC/DC transformer (19) connected between the DC voltage terminal of the electronic power system (13) and the power source (16), said DC/DC transformer (19) providing the electric machine (11) with a voltage in the motor mode of said electric machine (11), which voltage is higher than, or equal to or lower than, the voltage of the power source (16), said DC/DC transformer (19) charging the power source (16) in the generator mode of the electric machine (11).

2. The vehicle drive as claimed in claim 1, wherein the power source (16) has a negative pole (18) which is connected to a positive pole (14) of the DC voltage terminal of the electronic power system (13).

3. The vehicle drive as claimed in claim 1, wherein the power source (16) has a positive pole (17) which is connected to a negative pole (15) of the DC voltage terminal of the electronic power system (13), with the inverting, bidirectional DC/DC transformer (19) being connected therebetween.

4. The vehicle drive as claimed in claim 1, wherein the inverting, bidirectional DC/DC transformer (19) comprises at least two transistors (20 24), two diodes (21, 25) and an inductor (22).

5. The vehicle drive as claimed in claim 4, wherein a first transistor (20) is connected via its collector to the positive pole (17) of the power source (16), and both the cathode of a first diode (21) and a first terminal of the inductor (22) are connected to the emitter of the first transistor (21), with the anode of the first diode (21) being connected to the negative pole (15) of the electronic power system (13), and a second terminal of the inductor (22) being connected to the positive pole (14) of the electronic power system (13), and to the negative pole (15) of the electronic power system (13) with a capacitor (23) being arranged therebetween.

6. The vehicle drive as claimed in claim 5, wherein a second diode (25) is connected in parallel with the first transistor (20) in such a way that the cathode of the second diode (25) acts on the collector of the first transistor (20), and the anode of the second diode (25) acts on the emitter of the first transistor (20).

7. The vehicle drive as claimed in claim 6, wherein the anode of the second diode (25) is also connected to the first terminal of the inductor (22).

8. The vehicle drive as claimed in claim 5, wherein a second transistor (24) is connected in parallel with the first diode (21) in such a way that the cathode of the first diode (21) acts on the collector of the second transistor (24), and the anode of the first diode (21) acts on the emitter of the second transistor (24).

9. The vehicle drive as claimed in claim 8, wherein the collector of the second transistor (24) is also connected to the emitter of the first transistor (20) and thus to the anode of the second diode (25) and to the first terminal of the inductor (22).

10. The vehicle drive as claimed in claim 8, wherein the emitter of the second transistor (24) is also connected to the negative pole (15) of the electronic power system (13).

11. The vehicle drive as claimed in claim 1, wherein the inverting, bidirectional DC/DC transformer (19) can be changed into a non inverting, bidirectional DC/DC transformer by means of a selector switch (27) in order to reduce the voltage load so that, in the motor mode of the electric machine (11) the electric machine is provided with a voltage which is higher than, or equal to, the voltage of the power source (16) and, in the generator mode of the electric machine (11), the power source (16) is charged.

12. The vehicle drive as claimed in claim 11, wherein the selector switch (27) is connected to the positive pole (14) of the electronic power system (13) in such a way that, in a first position of the selective switch (27), the negative pole (18) of the power source (16) is connected to the positive pole (14) of the electronic power system (13), and, in a second position of the selective switch (27), the positive pole (17) of the power source (16) is connected to the positive pole (14) of the electronic power system (13).
